(19) United States
(12) Patent Application Publication
(10) Pub. No.: US 2013/0142058 A1
(43) Pub. Date: Jun. 6, 2013

(54) USING TD-SCDMA CONTINUOUS TIME PERIOD TO FACILITATE TD-SCDMA TO GSM WIRELESS HANDOVER

(71) Applicants: Tom Chin, San Diego, CA (US); Guangming Shi, San Diego, CA (US); Kuo-Chun Lee, San Diego, CA (US)

(72) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/516,651

(22) PCT Filed: Apr. 26, 2010
(86) PCT No.: PCT/US10/32423

§ 371 Date: Oct. 4, 2012

Related U.S. Application Data
(60) Provisional application No. 61/295,534, filed on Jan. 15, 2010.

(51) Int. Cl. H04W 24/02

(52) U.S. Cl. CPC H04W 24/02
USPC 370/252; 370/336; 370/331

(57) ABSTRACT

Wireless communication is implemented by a multi-mode user equipment (UE). The method includes selecting a continuous time period during a Time Division-Synchronous Code Division Multiple Access (TD-SCDMA) voice call. The voice call is via a Node B. The selected continuous time period includes multiple subframes. The method also includes preventing the UE from communicating with the Node B during the selected continuous time period, or at least preventing downlink communications with the Node B. The method further includes acquiring a Global System for Mobile communications (GSM) signal from at least one GSM cell during the selected continuous time period. The UE can handover to a selected GSM cell based on the measurements of the acquired GSM cell(s).

### CROSS-REFERENCE TO RELATED APPLICATIONS

This application claims the benefit of U.S. Provisional Patent Application No. 61/295,534, entitled “TD-SCDMA TO GSM WIRELESS HANDOVER,” filed on Jan. 15, 2010, which is expressly incorporated by reference herein in its entirety.

### BACKGROUND

1. Field

Aspects of the present disclosure relate generally to wireless communication systems, and more particularly, to handovers from Time Division-Synchronous Code Division Multiple Access (TD-SCDMA) cells to Global System for Mobile communications (GSM) cells.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In the initial deployment of TD-SCDMA systems, it is expected that the TD-SCDMA network will not cover all geographical areas and therefore mobile devices (or user equipment (UE)) will handover from TD-SCDMA cells to GSM cells to maintain communications. To reduce the service disruption and to select the best GSM cell for handover, the UE performs measurement on neighboring GSM cells for signal strength, frequency and timing, and also acquires BSIC (Base Station Identity Code) information.

This disclosure proposes methods to speed up the GSM cell measurement for a multimode terminal, such as a TD-SCDMA/GSM device.

### SUMMARY

In an aspect of the disclosure, a method of wireless communication is implemented by a multi-mode user equipment (UE). The method includes selecting a continuous time period during a Time Division-Synchronous Code Division Multiple Access (TD-SCDMA) voice call. The voice call is via a Node B. The selected continuous time period includes multiple subframes. The method also includes preventing the UE from communicating with the Node B during the selected continuous time period. The method further includes acquiring a Global System for Mobile communications (GSM) signal from at least one GSM cell during the selected continuous time period.

A method of wireless communication is implemented by a dual-mode user equipment (UE). The method includes selecting a continuous time period during a Time Division-Synchronous Code Division Multiple Access (TD-SCDMA) voice call. The voice call is via a Node B. The selected continuous time period includes multiple subframes. The method also includes preventing the UE from communicating with the Node B on a downlink during the selected continuous time period. The method further includes acquiring on the downlink a Global System for Mobile communications (GSM) signal from at least one GSM cell during the selected continuous time period.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a block diagram conceptually illustrating an exemplary timing of a GSM signal measurement.

FIG. 5 is a diagram conceptually illustrating an exemplary GSM timing.

FIG. 6 is a diagram conceptually illustrating an exemplary measurement timing.

FIG. 7 is a diagram conceptually illustrating an exemplary Adaptive Multi-Rate (AMR) frame format.

FIG. 8 is a diagram conceptually illustrating exemplary measurement timings.

FIG. 9 is a functional block diagram conceptually illustrating example blocks executed to implement the functional characteristics of one aspect of the present disclosure.

FIG. 10 is a functional block diagram conceptually illustrating example blocks executed to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

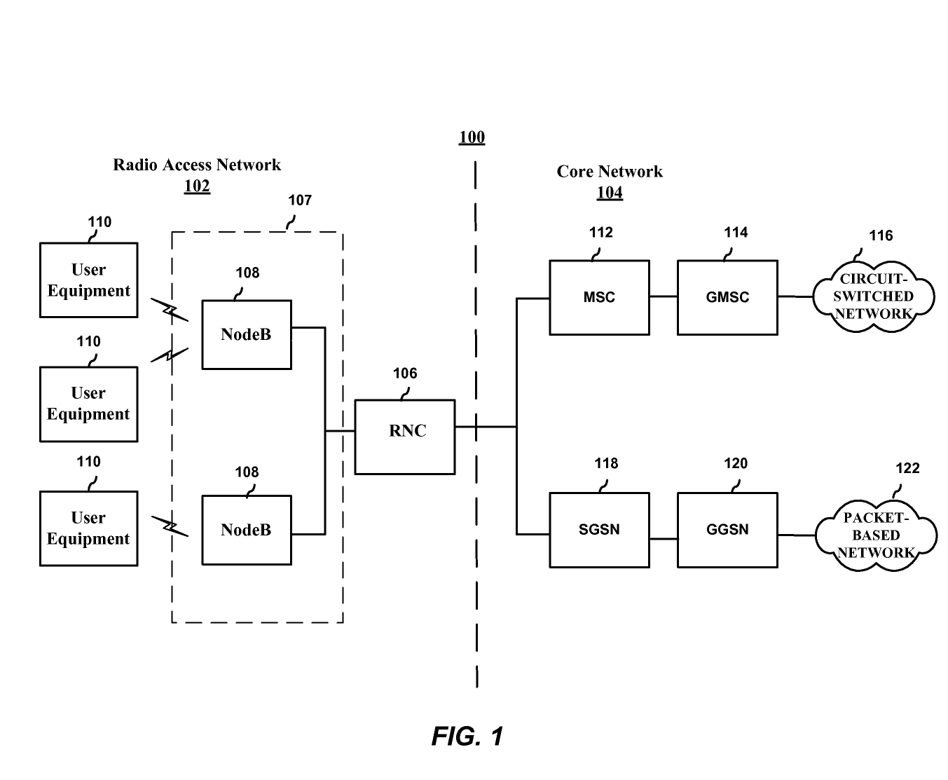

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

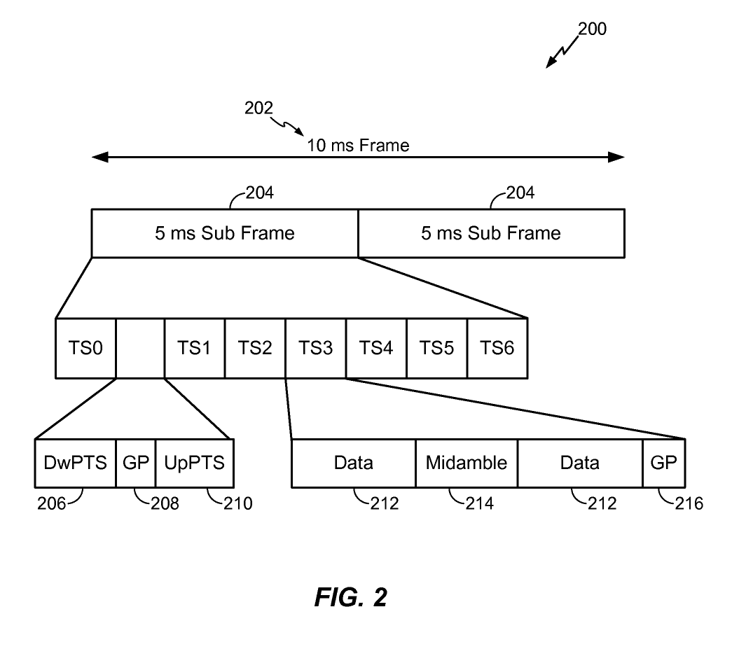

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

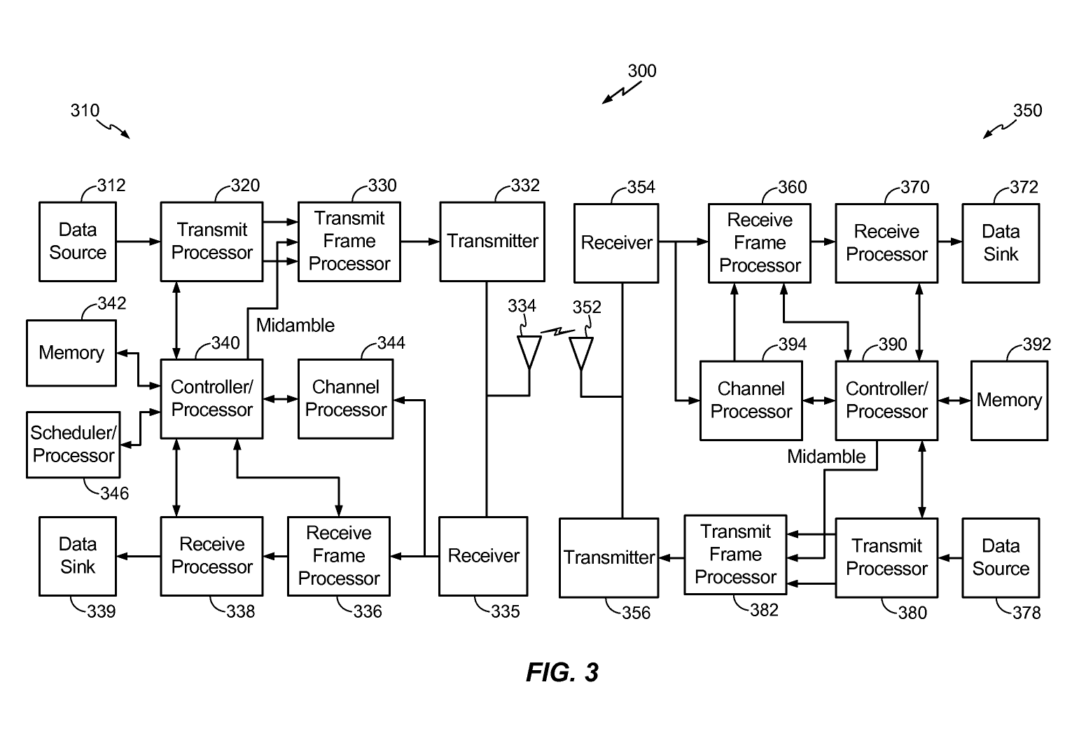

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

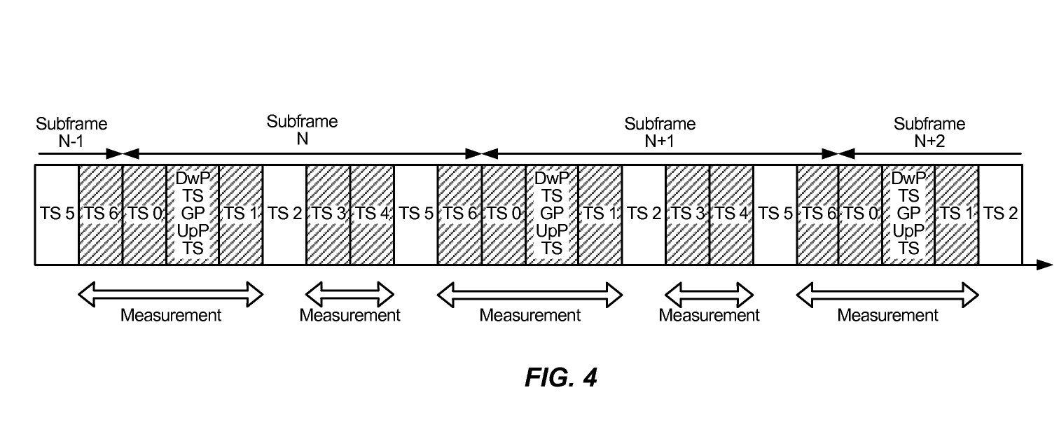

As noted above, a handover from a TD-SCDMA cell to a GSM cell may occur. The TD-SCDMA frame structure can provide some unused downlink and uplink time slots during which the UE can tune to the band and channel of the GSM cell in order to determine which GSM cell to be used for the handover. For example, FIG. 4 shows the UE can use time slots TS 3-4 and time slots TS 6-1 to perform the GSM measurement.

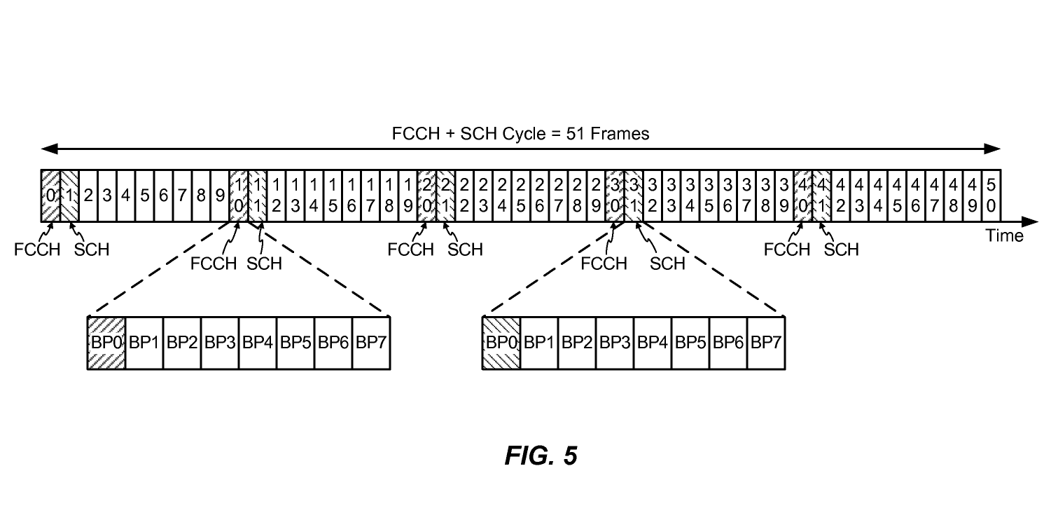

Referring to FIG. 5, in measuring GSM cells the UE acquires the FCCH (Frequency Correction Channel) and the SCH (Synchronization Channel). The Frequency Correction Channel is the frequency pilot of the channel. The Synchronization Channel can carry the Base Station Identity Code (BSIC) information.

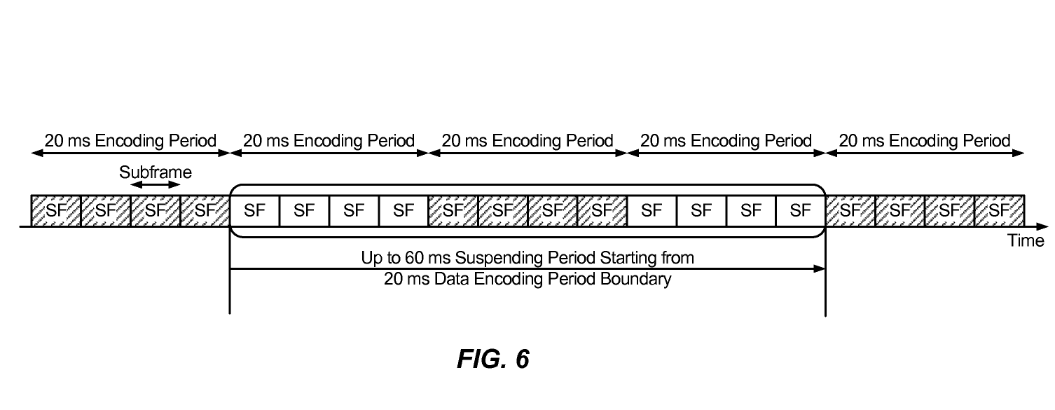

The GSM frame cycle for the Frequency Correction Channel and Synchronization Channel consists of 51 frames, each of 8 BPs (Burst Periods). The Frequency Correction Channel is in the first burst period (or BP 0) of frame 0, 10, 20, 30, 40, and the Synchronization Channel is in the first burst period of frame 1, 11, 21, 31, 41. Note that one burst period is 15/26 ms and one frame is 120/26 ms. Therefore, one 51 frame cycle is 235 ms. Also note that the inter-FCCH/SCH period is 10 frames (46.15 ms) or 11 frames (51.77 ms) in FIG. 6 (the last interval of the 51 frame cycle is 11 frames).

To measure the GSM cells, the UE acquires the Frequency Correction Channel in either a 10 or 11 frame interval, and acquires the Synchronization Channel and read the Base Station Identity Code.

However, because the number of TD-SCDMA continuous time slots can be as few as two or three time slots, a very limited time is available to perform measurement of GSM cells. Therefore, it takes a long time to measure the neighbor cells. Accordingly, the TD-SCDMA to GSM handover may not respond quickly.

According to an aspect of the present disclosure, the UE intentionally drops a few subframes to open up a continuous time period to speed up measurement. In one embodiment, the UE only opens up (i.e. neither transmits nor receives on the dedicated physical channel) at most 60 ms. During this continuous time period, the UE acquires the Frequency Correction Channel (FCCH), followed by the Synchronization Channel (SCH) (i.e. at most 12 frames, including the maximum 11 frames of inter-FCCH period and one frame containing the Synchronization Channel).

Because the TD-SCDMA standards often allocate 20 ms of voice or non-voice data into four subframes, in one embodiment the UE opens up a continuous 60 ms time interval starting from the boundary of the 20 ms (or four subframes). The continuous 60 ms time interval is used to perform GSM measurement. This concept reduces the impact of dropping data, and is illustrated in FIG. 6.

In yet another embodiment, when the UE has only circuit switched (e.g., 12.2 kbps) voice service, then a voice inactivity or silence time period can be used for measurement. The uplink voice silence time period can be detected by the voice codec locally at the UE. For down link voice silence, the time period can be detected by the received voice frames.

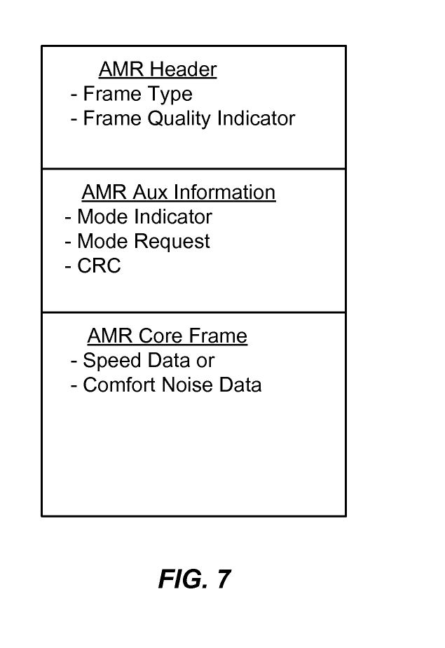

In one embodiment, the voice frame has a frame format as seen in FIG. 7. The 4-bit Frame Type field indicates different Adaptive Multi-Rate (AMR) frame types. As seen in TABLE 1, if the frame type is “8,” an Adaptive Multi-Rate Silence Descriptor (SID) exists. In other words, a Comfort Noise Frame exists and that time period can be used for measurement without impacting any voice traffic.

TABLE 1

| Frame | Frame content (AMR mode, comfort noise, or |
|---|---|
| Type | other) |
| 0 | AMR 4.75 kbit/s |
| 1 | AMR 5.15 kbit/s |
| 2 | AMR 5.90 kbit/s |
| 3 | AMR 6.70 kbit/s (PDC-EFR) |
| 4 | AMR 7.40 kbit/s (TDMA-EFR) |
| 5 | AMR 7.95 kbit/s |
| 6 | AMR 10.2 kbit/s |
| 7 | AMR 12.2 kbit/s (GSM-EFR) |
| 8 | AMR SID |
| 9 | GSM-EFR SID |
| 10 | TDMA-EFR SID |
| 11 | PDC-EFR SID |
| 12-14 | For future use |
| 15 | No Data (No transmission/No reception) |

In still another embodiment, the UE has separate downlink and uplink RF chains for tuning to different bands and frequencies and for operating in different radio access technologies (RATs). In this embodiment, the UE keeps the uplink on the TD-SCDMA network and tunes the downlink to the GSM network for measurement.

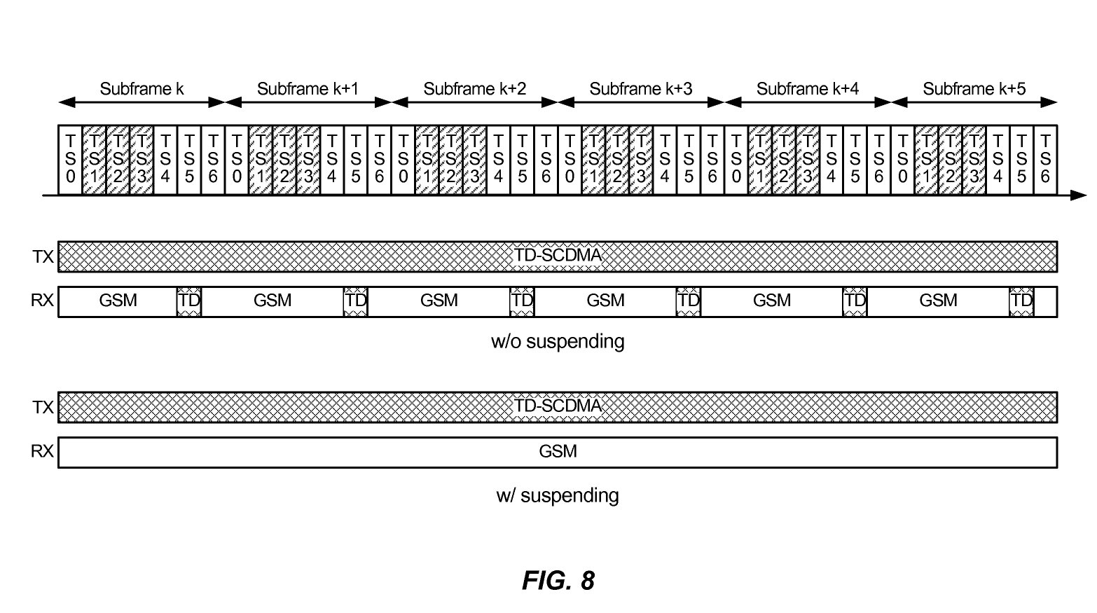

FIG. 8 shows two embodiments with the UE having separate uplink and downlink RF chains. In both cases, it is assumed the UE needs to receive on downlink time slot TS 5. In the first case, the TD-SCDMA reception is not suspended. That is, at time slot TS 5 the downlink RF chain is tuned to the TD-SCDMA cell to receive data. In the second case, the TD-SCDMA reception is suspended, i.e., the downlink chain remains tuned to the GSM network.

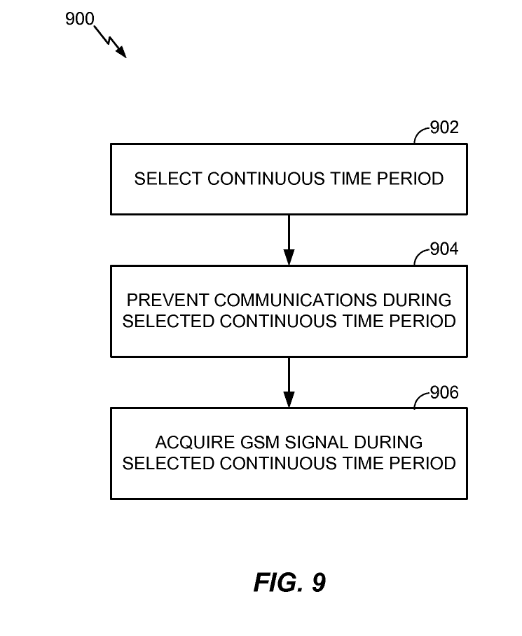

FIG. 9 is a functional block diagram 900 illustrating example blocks executed in conducting wireless communication according to one aspect of the present disclosure. In block 902, a multi-mode user equipment (UE) (which can include a dual mode device) selects a continuous time period during a TD-SCDMA voice call. The voice call is via a Node B. The selected continuous time period includes multiple subframes. The continuous time period can be based on a silence indicator and/or a vocoder frame boundary (e.g., 20 ms vocoder frame boundary). In block 904, the UE prevents itself from communicating with the Node B during the selected continuous time period. In block 906, the UE acquires a GSM signal from at least one GSM cell during the selected continuous time period. In one embodiment, the acquiring enables measurement of strength, frequency and timing, as well as Base Station Identity Code (BSIC) acquisition. Although not shown in FIG. 9, after acquiring the GSM signal, the UE can handover to a selected GSM cell based on the measurements of the acquired GSM cell(s).

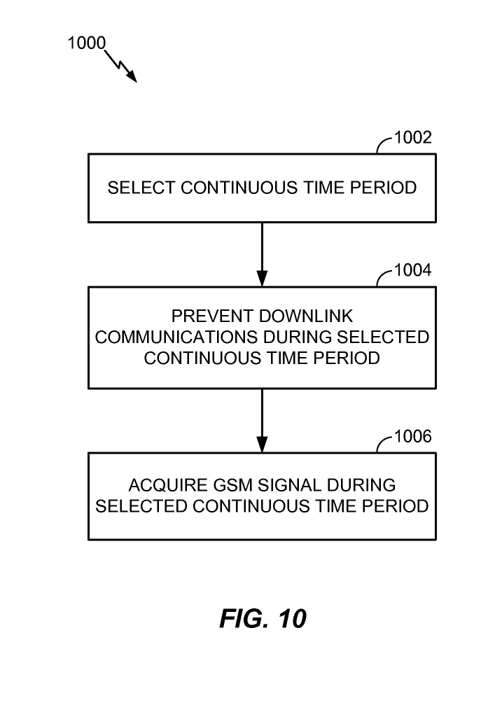

FIG. 10 is a functional block diagram 1000 illustrating example blocks executed in conducting wireless communication according to another aspect of the present disclosure. In block 1002, a multi-mode user equipment (UE) (which can include a dual mode device) selects a continuous time period during a TD-SCDMA voice call. The voice call is via a Node B. The selected continuous time period includes multiple subframes. The UE has separate uplink and downlink RF chains. In block 1004, the UE prevents itself from communicating on the downlink with the Node B during the selected continuous time period. In block 1006, the UE acquires a GSM signal from at least one GSM cell during the selected continuous time period. In one embodiment, the acquiring enables measurement of strength, frequency and timing, as well as Base Station Identity Code (BSIC) acquisition. Although not shown in FIG. 10, after acquiring the GSM signal, the UE can handover to a selected GSM cell based on the measurements of the acquired GSM cell(s).

The proposed methods can speed up GSM measurement for the TD-SCDMA multimode terminals. The proposed methods can also improve the handover latency performance.

In one configuration, the apparatus 350 for wireless communication includes means for selects a continuous time period during a TD-SCDMA voice call, means for preventing the UE from communicating with the Node B during the selected continuous time period, and means for acquiring a GSM signal from at least one GSM cell during the selected continuous time period. In one aspect, the aforementioned means may be the processor(s) 360, 370, 394, 390, 382, 380 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one” of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication implemented by a multi-mode user equipment, comprising:
selecting a continuous time period during a Time Division-Synchronous Code Division Multiple Access (TD-SCDMA) voice call, the voice call being via a Node B, the selected continuous time period including multiple subframes;
preventing the UE from communicating with the Node B during the selected continuous time period; and
acquiring a GSM signal from at least one Global System for Mobile communications (GSM) cell during the selected continuous time period.

2. The method of claim 1, further comprising handing over to a selected GSM cell based on the acquiring.

3. The method of claim 1, in which the acquiring comprises measuring signal strength, frequency and timing.

4. The method of claim 1, in which the acquiring comprises acquiring a Base Station Identity Code (BSIC).

5. The method of claim 1, in which the continuous time period is based on a silence indicator.

6. The method of claim 1, in which the continuous time period is based on a vocoder frame boundary.

7. The method of claim 1, further comprising:
dropping at least one subframe of the TD-SCDMA voice call to create the continuous time period prior to the selecting.

8. A method of wireless communication implemented by a dual-mode user equipment, comprising:
selecting a continuous time period during a Time Division-Synchronous Code Division Multiple Access (TD-SCDMA) voice call via a Node B, the selected continuous time period including multiple subframes;
preventing the UE from communicating with the Node B on a downlink during the selected continuous time period; and
acquiring on the downlink a Global System for Mobile communications (GSM) signal from at least one GSM cell during the selected continuous time period.

9. The method of claim 8, further comprising handing over to a selected GSM cell based on the acquiring.

10. The method of claim 8, in which the acquiring comprises measuring signal strength, frequency and timing from a Frequency Correction Channel (FCCH).

11. The method of claim 8, in which the acquiring comprises acquiring a Base Station Identity Code (BSIC) from a Synchronization Channel (SCH).

12. The method of claim 8, further comprising transmitting from the UE to the Node B on an uplink during the selected continuous time period, while acquiring the GSM signal.

13. The method of claim 8, further comprising:
dropping at least one subframe of the TD-SCDMA voice call to create the continuous time period prior to the selecting.

14. A user equipment (UE) of a time division-synchronous code division multiple access (TD-SCDMA) system, the UE comprising:
at least one processor configured to:
select a continuous time period during a Time Division-Synchronous Code Division Multiple Access (TD-SCDMA) voice call, the voice call being via a Node B, the selected continuous time period including multiple subframes;
prevent the UE from communicating with the Node B during the selected continuous time period; and
acquire a GSM signal from at least one Global System for Mobile communications (GSM) cell during the selected continuous time period; and
a memory coupled to said at least one processor.

15. The UE of claim 14, in which the at least one processor is further configured to hand over to a selected GSM cell based on the acquiring.

16. The UE of claim 14, in which the acquiring comprises measuring signal strength, frequency and timing.

17. The UE of claim 14, in which the acquiring comprises acquiring a Base Station Identity Code (BSIC).

18. The UE of claim 14, in which the continuous time period is based on a silence indicator.

19. The UE of claim 14, in which the continuous time period is based on a vocoder frame boundary.

20. The UE of claim 14, in which the at least one processor is further configured to drop at least one subframe of the TD-SCDMA voice call to create the continuous time period prior to the selection.

21. A user equipment (UE) of a time division-synchronous code division multiple access (TD-SCDMA) system, the UE comprising:
at least one processor configured to:
select a continuous time period during a Time Division-Synchronous Code Division Multiple Access (TD-SCDMA) voice call via a Node B, the selected continuous time period including multiple subframes;
prevent the UE from communicating with the Node B on a downlink during the selected continuous time period; and
acquire on the downlink a Global System for Mobile communications (GSM) signal from at least one GSM cell during the selected continuous time period; and
a memory coupled to said at least one processor.

22. The UE of claim 21, in which the at least one processor is further configured to hand over to a selected GSM cell based on the acquiring.

23. The UE of claim 21, in which the acquiring comprises measuring signal strength, frequency and timing from a Frequency Correction Channel (FCCH).

24. The UE of claim 21, in which the acquiring comprises acquiring a Base Station Identity Code (BSIC) from a Synchronization Channel (SCH).

25. The UE of claim 21, in which the at least one processor is further configured to transmit from the UE to the Node B on an uplink during the selected continuous time period, while acquiring the GSM signal.

26. The UE of claim 21, in which the at least one processor is further configured to drop at least one subframe of the TD-SCDMA voice call to create the continuous time period prior to the selection.

27. A computer readable medium having program code recorded thereon, said program code comprising:
program code to select a continuous time period during a Time Division-Synchronous Code Division Multiple Access (TD-SCDMA) voice call, the voice call being via a Node B, the selected continuous time period including multiple subframes;
program code to prevent the UE from communicating with the Node B during the selected continuous time period; and
program code to acquire a GSM signal from at least one Global System for Mobile communications (GSM) cell during the selected continuous time period.

28. A computer readable medium having program code recorded thereon, said program code comprising:
program code to select a continuous time period during a Time Division-Synchronous Code Division Multiple Access (TD-SCDMA) voice call via a Node B, the selected continuous time period including multiple subframes;
program code to prevent the UE from communicating with the Node B on a downlink during the selected continuous time period; and
program code to acquire on the downlink a Global System for Mobile communications (GSM) signal from at least one GSM cell during the selected continuous time period.

29. An apparatus for wireless communication in a time division-synchronous code division multiple access (TD-SCDMA) system, said apparatus comprising:
means for selecting a continuous time period during a Time Division-Synchronous Code Division Multiple Access (TD-SCDMA) voice call, the voice call being via a Node B, the selected continuous time period including multiple subframes;
means for preventing the UE from communicating with the Node B during the selected continuous time period; and
means for acquiring a GSM signal from at least one Global System for Mobile communications (GSM) cell during the selected continuous time period.

30. An apparatus for wireless communication in a time division-synchronous code division multiple access (TD-SCDMA) system, said apparatus comprising:
means for selecting a continuous time period during a Time Division-Synchronous Code Division Multiple Access (TD-SCDMA) voice call via a Node B, the selected continuous time period including multiple subframes;
means for preventing the UE from communicating with the Node B on a downlink during the selected continuous time period; and
means for acquiring on the downlink a Global System for Mobile communications (GSM) signal from at least one GSM cell during the selected continuous time period.
